(19) United States
(12) Patent Application Publication
(10) Pub. No.: US 2024/0124753 A1
(43) Pub. Date: Apr. 18, 2024

(54) COATINGS FOR MATERIALS TO REDUCE FRICTION AND ENERGY CONSUMPTION

(71) Applicant: BOARD OF TRUSTEES OF THE UNIVERSITY OF ARKANSAS, Little Rock, AR (US)

(72) Inventors: Min Zou, Fayetteville, AR (US); Sujan K. Ghosh, Fayetteville, AR (US); Josue A. Goss, Fayetteville, AR (US)

(73) Assignee: BOARD OF TRUSTEES OF THE UNIVERSITY OF ARKANSAS, Little Rock, AR (US)

(21) Appl. No.: 18/380,573

(22) Filed: Oct. 16, 2023

Related U.S. Application Data
(60) Provisional application No. 63/416,870, filed on Oct. 17, 2022.

(51) Int. Cl. C09J 145/00; B05D 1/02; C09J 11/04

(52) U.S. Cl. CPC C09J 145/00; B05D 1/02; C09J 11/04

(57) ABSTRACT

Embodiments pertain to a system with a first surface and a second surface operational to associate with one another, where at least one of the first surface and the second surface includes an adhesive layer and a graphite layer positioned on the adhesive layer, and where the graphite layer reduces friction between the first surface and the second surface while the adhesive layer maintains the position of the graphite layer on at least the first surface and the second surface. Additional embodiments pertain to methods of modifying a system that includes a first surface and a second surface by applying an adhesive material to at least one of the first surface and the second surface to form an adhesive layer on at least one of the first surface and the second surface; and applying a graphite material onto the adhesive layer to form a graphite layer on the adhesive layer.

### CROSS-REFERENCE TO RELATED PATENT APPLICATIONS

This application claims priority to U.S. Provisional Patent Application No. 63/416,870, filed on Oct. 17, 2022. The entirety of the aforementioned application is incorporated herein by reference.

### BACKGROUND

A need exists for improved systems that have reduced friction, reduced energy consumption, and increased reliability. Numerous embodiments of the present disclosure aim to address the aforementioned need.

### SUMMARY

In some embodiments, the present disclosure pertains to a system with a first surface and a second surface operational to associate with one another. In some embodiments, at least one of the first surface and the second surface includes an adhesive layer and a graphite layer positioned on the adhesive layer. In some embodiments, each of the first surface and the second surface includes an adhesive layer and a graphite layer positioned on the adhesive layer.

In some embodiments, each of the first surface and second surface independently includes, without limitation, a metal surface, a steel surface, a galvanized steel surface, a plastic surface, a polymer surface, a composite surface, a ceramic surface, or combinations thereof. In some embodiments, the graphite layers of the first surface and the second surface face one another. In some embodiments, the graphite layer of at least one of the first surface and the second surface reduces the friction between the first surface and the second surface while the adhesive layer maintains the position of the graphite layer on at least one of the first surface and the second surface.

In some embodiments, the systems of the present disclosure include a conveyor system. In some embodiments, each of the first surface and the second surface in the conveyor system independently includes, without limitation, a flat belt surface, a conveyor belt surface, a conveyor bed surface, or combinations thereof.

Additional embodiments of the present disclosure pertain to methods of modifying a system that includes a first surface and a second surface operational to associate with one another. In some embodiments, the methods of the present disclosure include: applying an adhesive material to at least one of the first surface and the second surface to form an adhesive layer on at least one of the first surface and the second surface; and applying a graphite material onto the adhesive layer to form a graphite layer on the adhesive layer.

### DESCRIPTION OF THE DRAWINGS

FIG. 1A provides an illustration of a system of the present disclosure.

FIG. 1B provides an illustration of a conveyor system that includes the components of the present disclosure.

FIG. 2 provides a schematic of a polydopamine (PDA)/graphite coating on a conveyor bed.

FIGS. 3A-3B summarize tribological test results of spray-coated PDA/20 vol % graphite coating on galvanized steel and a conveyor belt. Shown are comparisons of the coefficients of friction (COF) (FIG. 3A) and acoustic emission profile (FIG. 3B) of the coated and uncoated materials.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components that includes one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Surfaces interact with each other in numerous systems to cause friction and energy consumption. For instance, conveyor systems are widely used in the manufacturing and distribution of products, which involve assembly, transportation, warehousing, and order picking across many industries, such as the parcel, baggage, warehouse distribution, e-commerce, manufacturing, food, beverage, and pharmaceutical industries. The global conveyor market was $5.6 billion in 2021 and is expected to grow at a compound annual growth rate (CAGR) of 4.5% to reach $7.62 billion by 2028. Flat belt conveyors constitute 26.6% of the global conveyor market and are the fastest-growing conveyor type.

A flat belt conveyor uses a looped belt sliding on a slider bed to move raw materials through the manufacturing cycle or finished products through the distribution cycle. Currently, the sliding belt and slider bed interface is not lubricated and has high sliding friction, with a coefficient of friction (COF) as high as 0.8 at heavy loads. The interface friction contributes up to 60% of the total energy losses in a flat conveyor system.

Therefore, flat belt conveyor systems have low energy efficiency, which leads to a large amount of energy waste by industries that use flat belt conveyors. For example, the estimated energy waste is more than $40M annually for UPS distribution centers alone.

As such, a need exists for improved systems, including conveyor systems, that have reduced friction, reduced energy consumption, and increased reliability. Numerous embodiments of the present disclosure aim to address the aforementioned need.

Systems

In some embodiments, the present disclosure pertains to a system with a first surface and a second surface operational to associate with one another. In some embodiments, at least one of the first surface and the second surface includes an adhesive layer and a graphite layer positioned on the adhesive layer. In some embodiments, each of the first surface and the second surface includes an adhesive layer and a graphite layer positioned on the adhesive layer.

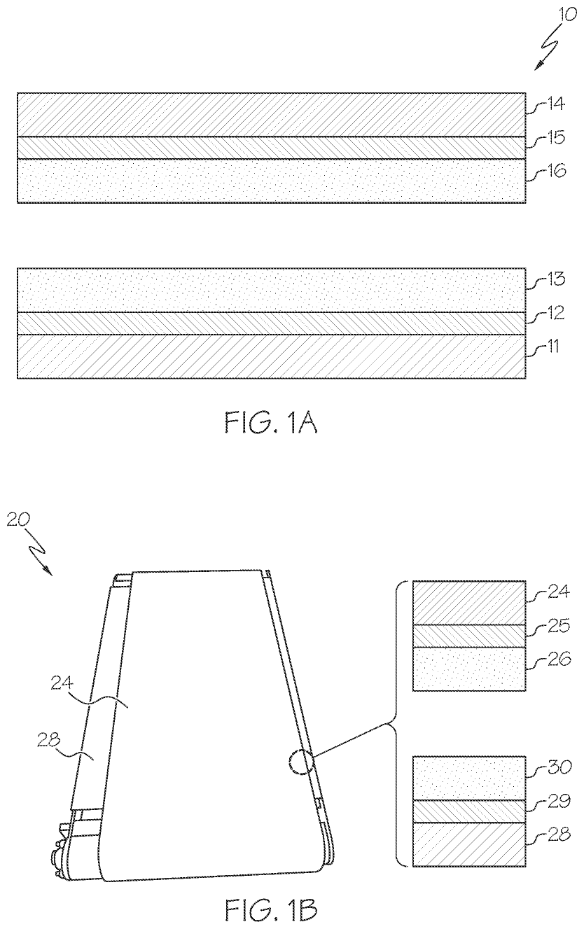

An example of a system of the present disclosure is illustrated in FIG. 1A as system 10. In this example, system 10 includes a first surface 11 and a second surface 14. First surface 11 and second surface 14 are operational to associate with one another. Additionally, each of the first surface 11 and the second surface 14 includes an adhesive layer and a graphite layer positioned on the adhesive layer. In particular, first surface 11 includes an adhesive layer 12 and a graphite layer 13 positioned on the adhesive layer 12. Similarly, second surface 14 includes an adhesive layer 15 and a graphite layer 16 positioned on the adhesive layer 15. As set forth in more detail herein, the systems of the present disclosure can have numerous embodiments.

Adhesive layers

The systems of the present disclosure can have various adhesive layers. For instance, in some embodiments, the adhesive layer includes an adhesive material. In some embodiments, the adhesive material includes a polymer. In some embodiments, the polymer includes polydopamine (PDA).

The adhesive layers of the present disclosure can have various arrangements. For instance, in some embodiments, the adhesive layer of the first surface is sandwiched between the first surface and the graphite layer of the first surface. An example of such an arrangement is illustrated in FIG. 1A, where adhesive layer 12 of first surface 11 is sandwiched between first surface 11 and graphite layer 13.

In some embodiments, the adhesive layer of the second surface is sandwiched between the second surface and the graphite layer of the second surface. An example of such an arrangement is also illustrated in FIG. 1A, where adhesive layer 15 of second surface 14 is sandwiched between first surface 14 and graphite layer 16.

Graphite layers

The systems of the present disclosure can have various graphite layers. For instance, in some embodiments, the graphite layer is in the form of a coating.

In some embodiments, the graphite layer includes a dispersion of graphite materials. In some embodiments, the graphite layer is derived from a dispersion of graphite materials. In some embodiments, the dispersion excludes polytetrafluorethylene (PTFE). In some embodiments, the graphite materials include non-expanded graphite. In some embodiments, the graphite materials include non-exfoliated graphite. In some embodiments, the graphite materials include ball-milled graphite. In some embodiments, the ball milling of the graphite can help breakdown large graphite particles to smaller ones and thereby facilitate the formation of a more uniform coating on a desired surface. In some embodiments, the graphite layer excludes polytetrafluorethylene (PTFE).

In some embodiments, the graphite layer is derived from a dispersion that includes at least 10 vol % graphite. In some embodiments, the graphite layer is derived from a dispersion that includes at least 15 vol % graphite. In some embodiments, the graphite layer is derived from a dispersion that includes at least 20 vol % graphite.

In some embodiments, the graphite layer has a thickness ranging from about 1 μm to about 1 mm. In some embodiments, the graphite layer has a thickness ranging from about 1 μm to about 250 μ. In some embodiments, the graphite layer has a thickness of at least about 50 μm. In some embodiments, the graphite layer has a thickness of at least about 100 μm. In some embodiments, the graphite layer has a thickness of at least about 150 μm. In some embodiments, the graphite layer has a thickness of at least about 200 μm. In some embodiments, the graphite layer has a thickness of at least about 250 μm. In some embodiments, the graphite layer has a thickness of at least about 500 μm. In some embodiments, the graphite layer has a thickness of at least about 750 μm. In some embodiments, the graphite layer has a thickness of at least about 1 mm. In some embodiments, the graphite layer has a thickness of less than 15 μm. In some embodiments, the graphite layer has a thickness of less than 10 μm. In some embodiments, the graphite layer has a thickness ranging from about 5 μm to about 10 μm. In some embodiments, the graphite layer has a thickness ranging from about 7 μm to about 8 μm.

First and second surfaces

The systems of the present disclosure can include various first and second surfaces. For instance, in some embodiments, each of the first surface and second surface independently includes, without limitation, a metal surface, a steel surface, a galvanized steel surface, a plastic surface, a polymer surface, a composite surface, a ceramic surface, or combinations thereof.

In some embodiments, one of the first surface or the second surface includes an adhesive layer and a graphite layer positioned on the adhesive layer. In some embodiments, the graphite layer of at least one of the first surface and the second surface reduces the friction between the first surface and the second surface while the adhesive layer maintains the position of the graphite layers on at least one of the first surface and the second surface.

In some embodiments, each of the first surface and the second surface includes an adhesive layer and a graphite layer positioned on the adhesive layer. In some embodiments, the graphite layers of the first surface and the second surface face one another. In some embodiments, the graphite layers of the first surface and the second surface reduce the friction between the first surface and the second surface while the adhesive layers on the first surface and the second surface maintain the position of the graphite layers on the first surface and the second surface.

In some embodiments, the graphite layers of the first surface and the second surface reduce the coefficient of friction (COF) between the first surface and the second surface by at least 20% when compared to first and second surfaces without graphite layers and adhesive layers. In some embodiments, the graphite layers of the first surface and the second surface reduce the coefficient of friction (COF) between the first surface and the second surface by at least 30% when compared to first and second surfaces without graphite layers and adhesive layers.

Systems

The systems of the present disclosure can be in various forms. For instance, in some embodiments, the systems of the present disclosure include, without limitations, conveyor systems, gaskets, rollers, wheels, gears, chains, hoists, or combinations thereof.

In some embodiments, the systems of the present disclosure include a conveyor system. In some embodiments, each of the first surface and the second surface of the conveyor system independently includes, without limitation, a flat belt surface, a conveyor belt surface, a conveyor bed surface, or combinations thereof. In some embodiments, the conveyor system includes a flatbed conveyor system. In some embodiments, one of the first surface or the second surface of the conveyor system includes an adhesive layer and a graphite layer positioned on the adhesive layer. In some embodiments, each of the first surface and the second surface of the conveyor system includes an adhesive layer and a graphite layer positioned on the adhesive layer.

An example of a conveyor system of the present disclosure is illustrated in FIG. 1B as conveyor system 20. In this example, the first surface of the conveyor system is in the form of a conveyor belt surface 24, which includes adhesive layer 25 and graphite layer 26. The second surface of the conveyor system is in the form of conveyor bed surface 28, which also includes adhesive layer 29 and graphite layer 30. In some embodiments, adhesive layers 29 and 25 maintain the position of the graphite layers 30 and 26 on the conveyor bed surface 28 and conveyor belt surface 24, respectively.

In the example illustrated in FIG. 1B, graphite layers 30 and 26 face one another. As such, in some embodiments, graphite layers 30 and 26 reduce the friction between conveyor bed surface 28 and conveyor belt surface 24. For instance, in some embodiments, graphite layers 30 and 26 reduce the coefficient of friction (COF) between the conveyor bed surface 28 and conveyor belt surface 24 by at least 20% when compared to conveyor bed and conveyor belt surfaces without graphite layers and adhesive layers. In some embodiments, graphite layers 30 and 26 reduce the coefficient of friction (COF) between the conveyor bed surface 28 and conveyor belt surface 24 by at least 30% when compared to conveyor bed and conveyor belt surfaces without graphite layers and adhesive layers.

Methods of modifying systems

Additional embodiments of the present disclosure pertain to methods of modifying a system that includes a first surface and a second surface operational to associate with one another. In some embodiments, the methods of the present disclosure include: applying an adhesive material to at least one of the first surface and the second surface to form an adhesive layer on at least one of the first surface and the second surface; and applying a graphite material onto the adhesive layer to form a graphite layer on the adhesive layer. As set forth in more detail herein, the methods of the present disclosure can have numerous embodiments.

Application of adhesive materials and graphite materials

The methods of the present disclosure may utilize various methods to apply adhesive materials and graphite materials. For instance, in some embodiments, each of the application steps independently includes, without limitation, dip coating, spray coating, spin coating, roll coating, soaking in a dispersion, printing, or combinations thereof. In some embodiments, each of the application steps includes spray coating.

In some embodiments, the adhesive material and the graphite material are applied to one of the first surface or the second surface to form the adhesive layer and the graphite layer on the first surface or the second surface. In some embodiments, the adhesive material and the graphite material are applied to each of the first surface and the second surface to form the adhesive layer and the graphite layer on the first surface and the second surface.

Adhesive materials and adhesive layers

The methods of the present disclosure may utilize various types of adhesive materials. For instance, in some embodiments, the adhesive material includes a polymer. In some embodiments, the polymer includes PDA.

The methods of the present disclosure may be utilized to form various arrangements of adhesive layers. For instance, in some embodiments, the adhesive layer of the first surface becomes sandwiched between the first surface and the graphite layer of the first surface. In some embodiments, the adhesive layer of the second surface becomes sandwiched between the second surface and the graphite layer of the second surface.

Graphite materials and layers

The methods of the present disclosure may also utilize various types of graphite materials. For instance, in some embodiments, the graphite material includes non-expanded graphite. In some embodiments, the graphite material includes non-exfoliated graphite. In some embodiments, the graphite material includes ball-milled graphite. In some embodiments, the graphite material is in a dispersion that excludes polytetrafluorethylene (PTFE).

In some embodiments, the graphite material is in the form of a dispersion that includes at least 10 vol % graphite. In some embodiments, the graphite material is in the form of a dispersion that includes at least 15 vol % graphite. In some embodiments, the graphite material is in the form of a dispersion that includes at least 20 vol % graphite.

The methods of the present disclosure may be utilized to form various types of graphite layers. For instance, in some embodiments, the graphite layer is in the form of a coating. In some embodiments, the graphite layer has a thickness ranging from about 1 μm to about 1 mm. In some embodiments, the graphite layer has a thickness ranging from about 1 μm to about 250 μm. In some embodiments, the graphite layer has a thickness of at least about 50 μm. In some embodiments, the graphite layer has a thickness of at least about 100 μm. In some embodiments, the graphite layer has a thickness of at least about 150 μm. In some embodiments, the graphite layer has a thickness of at least about 200 μm. In some embodiments, the graphite layer has a thickness of at least about 250 μm. In some embodiments, the graphite layer has a thickness of at least about 500 μm. In some embodiments, the graphite layer has a thickness of at least about 750 μm. In some embodiments, the graphite layer has a thickness of at least about 1 mm. In some embodiments, the graphite layer has a thickness of less than 15 μm. In some embodiments, the graphite layer has a thickness of less than 10 μm. In some embodiments, the graphite layer has a thickness ranging from about 5 μm to about 10 μm. In some embodiments, the graphite layer has a thickness ranging from about 7 μm to about 8 μm.

First and second surfaces

The methods of the present disclosure may be utilized to modify various types of first and second surfaces. For instance, in some embodiments, each of the first surface and second surface independently includes, without limitation, a metal surface, a steel surface, a galvanized steel surface, a plastic surface, a polymer surface, a composite surface, a ceramic surface, or combinations thereof.

In some embodiments, the methods of the present disclosure may be utilized to reduce friction between the first surface and the second surface. For instance, in some embodiments, the formed graphite layers on the first surface and the second surface may reduce the coefficient of friction (COF) between the first surface and the second surface by at least 20% when compared to first and second surfaces without graphite layers and adhesive layers. In some embodiments, the formed graphite layers on the first surface and the second surface may reduce the coefficient of friction (COF) between the first surface and the second surface by at least 30% when compared to first and second surfaces without graphite layers and adhesive layers.

Systems

The methods of the present disclosure may be utilized to modify the surfaces of various systems. For instance, in some embodiments, the systems of the present disclosure include, without limitations, conveyor systems, gaskets, rollers, wheels, gears, chains, hoists, or combinations thereof.

In some embodiments, the systems of the present disclosure include a conveyor system, such as conveyor system 20 illustrated in FIG. 1B and described supra. In some embodiments, the conveyor system includes a flatbed conveyor system. In some embodiments, each of the first surface and the second surface of the conveyor system includes, without limitation, a flat belt surface, a conveyor belt surface, a conveyor bed surface, or combinations thereof.

In some embodiments, the adhesive material and the graphite material are applied to each of the first surface and the second surface to form the adhesive layer and the graphite layer on the first surface and the second surface of the conveyor system. In some embodiments, the first modified surface includes a conveyor belt surface and the second modified surface includes a conveyor bed surface. In some embodiments, the graphite layers of the conveyor bed surface and the conveyor belt surface reduce the friction between the conveyor bed surface and the conveyor belt surface. In some embodiments, the adhesive layers on the conveyor bed surface and the conveyor belt surface maintain the position of the graphite layers on the conveyor bed surface and the conveyor belt surface. In some embodiments, the graphite layers of the conveyor bed surface and the conveyor belt surface reduce the coefficient of friction (COF) between the conveyor bed surface and the conveyor belt surface by at least 20% when compared to conveyor bed and conveyor belt surfaces without graphite layers and adhesive layers. In some embodiments, the graphite layers of the conveyor bed surface and the conveyor belt surface reduce the coefficient of friction (COF) between the conveyor bed and the conveyor belt by at least 30% when compared to conveyor bed and conveyor belt surfaces without graphite layers and adhesive layers.

Applications and Advantages

The methods and systems of the present disclosure can have numerous advantages. For instance, in some embodiments, PDA/graphite coatings applied to conveyor system surfaces can reduce the COF of conveyor systems by 33%, which can in turn result in energy-saving and sustainability. Moreover, in some embodiments, such PDA/graphite coatings can reduce acoustic emissions of a conveyor system by half, which can have direct health benefits to operating personnel.

Additionally, PDA/graphite coatings of the systems of the present disclosure are more cost effective when compared to alternative solutions. Additionally, the PDA/graphite coatings of the systems of the present disclosure are eco-friendly due to the nonhazardous nature of graphite and PDA.

As such, the systems of the present disclosure can have numerous applications. For instance, in some embodiments, the systems of the present disclosure can have applications in conveyor systems, gaskets, rollers, wheels, gears, chains, and hoists.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Polydopamine/Graphite Coating for Flat Belt Conveyor Materials to Reduce Energy Consumption

Polydopamine (PDA) is a bio-inspired adhesive material that can adhere to many material surfaces and act as a binder between a surface and a coating. PDA, when used as an underlayer, can improve the adhesion of coatings to the substrate and thus improve the coating's durability. A low-friction graphite coating deposited on the conveyor bed and belt coated with a PDA underlayer can reduce the coefficient of friction (COF) between the conveyor bed and belt and thus reduce the energy consumption in a conveyor system.

This Example is related to applying a spray-coated PDA/graphite coating on the bed and belt materials of a conveyor to reduce the COF between them, while in the meantime, reducing the noise level and maintaining a smooth operation. The PDA layer increases the graphite adhesion to substrates, whereas the graphite coating acts as a low-friction solid lubricant.

In particular, a PDA underlayer was spray-coated on the conveyor bed and/or belt as an adhesive underlayer. A graphite dispersion was then spray-coated over the PDA layer to provide a low-friction coating. PDA/graphite coating is investigated in this Example for coating galvanized steel and traditional conveyor belt. However, this coating can be applied to any conveyor bed and belt materials.

### Example 1.1. Materials

A 1 in. ×1 in. square of galvanized steel plate was used as the substrate. A PDA solution was prepared using Trizma base (Sigma Aldrich) and Dopamine Hydrochloride (Sigma Aldrich). A water-based graphite dispersion (AMLube 1127) was used for the graphite coating.

### Example 1.2. Preparation of the materials

The galvanized steel plate was roughened using 320-grade sandpaper for better deposition of PDA coatings. The PDA solution was prepared by mixing 0.12 g of Trizma base and 0.20 g of dopamine hydrochloride in 100 ML of deionized (DI) water at 60° C. for 45 minutes. The PDA solution was sprayed over the substrates using an in-house spray coater with a 1 mm nozzle (ST-5, Lumina, Japan) for 30 cycles at 5 psi pressure at a distance of 8 inches between the spray head and the substrate. Once sprayed, the PDA-coated substrate was placed on a hot plate at 120° C. for 4 minutes.

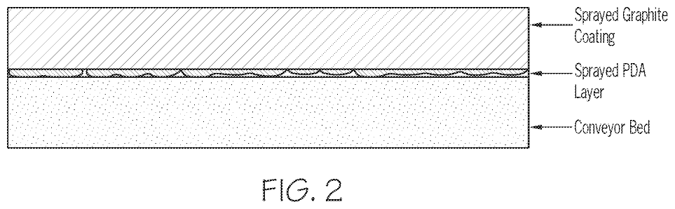

To break down the graphite particles, the graphite dispersion was diluted using DI water at a 1:4 ratio to form a 20 vol % graphite dispersion. The graphite dispersion was then placed in a stainless steel ball mill jar. Six stainless steel balls of two different sizes, two balls of 12.70 mm diameter and four balls of 6.35 mm diameter, were dropped in the ball mill jar. The ball mill jar was then placed in the rocking arm of the ball milling equipment (8000D Mixer Mill, Spex Sampleprep, USA) and was ball milled for an hour at 1715 RPM. The ball-milled dispersion was filtered using a 40 μm filter to remove large particle aggregates and spray-coated over the PDA-coated substrates. The coating then went through a two-step heating process: 120° C. for 4 minutes on a hotplate and 200° C. for 8 minutes in an oven. The resulting thickness of the graphite coating was 7-8 μm. FIG. 2 provides a depiction of the formed PDA/graphite coatings.

### Example 1.3. Functional Analyses of the Prepared Materials

Tribological tests were conducted to compare the COF and noise levels of the conveyor bed and conveyor belt system with and without the PDA/graphite coatings. The tests were performed at 1N force and 250 RPM speed. A 1.5 mm×6 mm rectangular piece of the belt was used as the counter-face in the tribological tests. The acoustic emission of these samples was studied at 3.43 N force, 10 mm/s speed, and 10 mm stroke length using a linear reciprocating test setup. A Cr-Steel ball of 6.35 mm diameter was used as the counter-face.

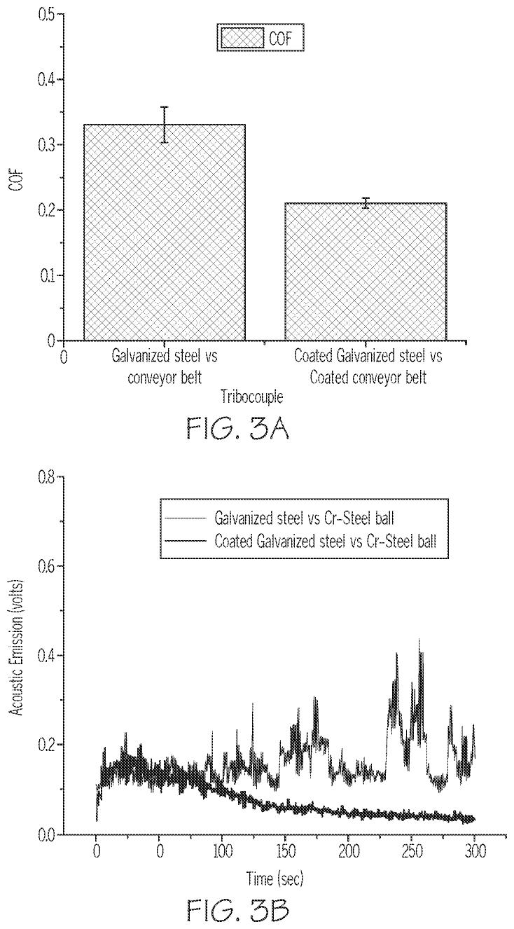

The test results are shown in FIGS. 3A-3B. The test results demonstrate that the coated conveyor belt and coated galvanized tribocouple show a 33% reduction in average COF when compared to uncoated versions of the belt and galvanized steel tribocouple, respectively (FIG. 3A). The graphite contact is likely to be responsible for the lower COF in the coated tribocouple. Additionally, the coated conveyor belt and coated galvanized tribocouple reduce the average acoustic emission by half and show a smoother operation in the linear reciprocating tests setup (FIG. 3B).

### Example 1.4. Discussion and advantages

Graphite is a solid lubricant that shows low COF. The coatings, however, have poor adhesion to substrates. In this Example, Applicant demonstrated that spray-coated PDA can help adhere graphite coating to conveyor beds and belts and help reduce the COF between the conveyor bed and belt by 33% while reducing the acoustic emission by 50%. The reduction in COF can result in significant energy savings.

Sprayable PDA/graphite coating can reduce energy consumption by 30% by reducing the COF between the conveyor bed and belt and increasing conveyor reliability by smoothening the operation of the conveyor. The PDA/Graphite coating not only can reduce the COF of the galvanized steel bed but also can be used to reduce the COF of the other type of conveyor materials.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A system comprising:
a first surface and a second surface operational to associate with one another, wherein at least one of the first surface and the second surface comprises an adhesive layer and a graphite layer positioned on the adhesive layer.

2. The system of claim 1, wherein the adhesive layer comprises an adhesive material comprising a polymer.

3. The system of claim 2, wherein the polymer comprises polydopamine (PDA).

4. The system of claim 1, wherein the graphite layer is derived from a dispersion of graphite materials.

5. The system of claim 4, wherein the graphite materials comprise non-exfoliated graphite.

6. The system of claim 1, wherein each of the first surface and second surface are independently selected from the group consisting of a metal surface, a steel surface, a galvanized steel surface, a plastic surface, a polymer surface, a composite surface, a ceramic surface, or combinations thereof.

7. The system of claim 1, wherein the graphite layer of at least one of the first surface and the second surface reduces the friction between the first surface and the second surface, and wherein the adhesive layer maintains the position of the graphite layer on at least one of the first surface and the second surface.

8. The system of claim 1, wherein one of the first surface or the second surface comprises an adhesive layer and a graphite layer positioned on the adhesive layer.

9. The system of claim 1, wherein each of the first surface and the second surface comprises an adhesive layer and a graphite layer positioned on the adhesive layer.

10. The system of claim 9, wherein the graphite layers of the first surface and the second surface reduce the friction between the first surface and the second surface, and wherein the adhesive layers on the first surface and the second surface maintain the position of the graphite layers on the first surface and the second surface.

11. The system of claim 1, wherein the system comprises a conveyor system.

12. The system of claim 11, wherein the first surface comprises a conveyor belt surface, and wherein the second surface comprises a conveyor bed surface.

13. The system of claim 12, wherein each of the first surface and the second surface comprises an adhesive layer and a graphite layer positioned on the adhesive layer.

14. The system of claim 13, wherein the graphite layers of the conveyor bed surface and the conveyor belt surface reduce the friction between the conveyor bed surface and the conveyor belt surface, and wherein the adhesive layers on the conveyor bed surface and the conveyor belt surface maintain the position of the graphite layers on the conveyor bed surface and the conveyor belt surface.

15. A method of modifying a system comprising a first surface and a second surface operational to associate with one another, said method comprising:
applying an adhesive material to at least one of the first surface and the second surface to form an adhesive layer on at least one of the first surface and the second surface; and
applying a graphite material onto the adhesive layer to form a graphite layer on the adhesive layer.

16. The method of claim 15, wherein each of the applying steps comprises spray coating.

17. The method of claim 15, wherein the method is utilized to reduce friction between the first surface and the second surface.

18. The method of claim 15, wherein the adhesive material comprises a polymer comprising polydopamine (PDA).

19. The method of claim 15, wherein the graphite material comprises non-exfoliated graphite.

20. The method of claim 15, wherein the adhesive material and the graphite material are applied to one of the first surface or the second surface to form the adhesive layer and the graphite layer on the first surface or the second surface.

21. The method of claim 15, wherein the adhesive material and the graphite material are applied to each of the first surface and the second surface to form the adhesive layer and the graphite layer on the first surface and the second surface.

22. The method of claim 15, wherein the system comprises a conveyor system.

23. The method of claim 22, wherein the first surface comprises a conveyor belt surface, and wherein the second surface comprises a conveyor bed surface.

24. The method of claim 23, wherein the adhesive material and the graphite material are applied to each of the first surface and the second surface to form the adhesive layer and the graphite layer on the first surface and the second surface.

25. The method of claim 24, wherein the graphite layers of the conveyor bed surface and the conveyor belt surface reduce the friction between the conveyor bed surface and the conveyor belt surface, and wherein the adhesive layers on the conveyor bed surface and the conveyor belt surface maintain the position of the graphite layers on the conveyor bed surface and the conveyor belt surface.
